(19) United States
(12) Patent Application Publication
(10) Pub. No.: US 2024/0211754 A1
(43) Pub. Date: Jun. 27, 2024

(54) METHOD AND APPARATUS FOR SIMULTANEOUS TRAINING AND CORRECTION OF ARTIFICIAL NEURAL NETWORK AND DATASET

(71) Applicant: ELECTRONICS AND TELECOMMUNICATIONS RESEARCH INSTITUTE, Daejeon (KR)

(72) Inventors: IL KYU PARK, Daejeon (KR); Bonki KOO, Daejeon (KR)

(73) Assignee: ELECTRONICS AND TELECOMMUNICATIONS RESEARCH INSTITUTE, Daejeon (KR)

(21) Appl. No.: 18/447,836

(22) Filed: Aug. 10, 2023

(30) Foreign Application Priority Data
Dec. 27, 2022 (KR) 10-2022-0185954

(51) Int. Cl. G06N 3/08

(52) U.S. Cl. CPC G06N 3/08

(57) ABSTRACT

An embodiment of the present disclosure discloses a method of operating a computing device for mapping data from different domains to a common joint embedding space, and the method of operating a computing device includes training a mapping neural network constituting a joint embedding space using an input dataset, generating a prediction matrix of an input dataset using the mapping neural network, and generating a merging dictionary merging classes from the prediction matrix to correct the input dataset.

### CROSS-REFERENCE TO RELATED APPLICATION

This application claims priority to and the benefit of Korean Patent Application No. 10-2022-0185954, filed on Dec. 27, 2022, the disclosure of which is incorporated herein by reference in its entirety.

### BACKGROUND

### 1. Field of the Invention

The present disclosure relates to an cross-domain data matching and classification technology for predicting a correspondence between data belonging to different domains using deep learning.

### 2. Discussion of Related Art

In general, a classification technology using a neural network performs classification by converting input data into a probability of each class through a multi-layer network. In the currently widely used deep learning technology, a neural network may be composed of a large number of layers and process data including classification with high accuracy. In this case, a considerable amount of data is required.

Meanwhile, in the classification using the neural network, in the case of a matching and classifying operation that calculates a relationship between data (video and audio, audio and text, etc.) of different domains, the same neural network may not be used because the characteristics of data are different for each domain, there is a need for a method of representing the relationship between the data.

Conventionally, a joint embedding space method is often used to calculate the relationship between the data in the domain. The joint embedding space method is a method of generating correspondences between domains by mapping data of different domains to a common high-dimensional embedding space, and neural networks responsible for mapping is used. The neural networks are trained using a dataset.

### SUMMARY OF THE INVENTION

The present disclosure is to improve a training efficacy of a neural network while refining a dataset by performing an operation of correcting data that is less related to an error of the dataset and a problem to be trained using the neural network at the same time as the training of the neural network.

An embodiment of the present disclosure discloses a method of operating a computing device for mapping data from different domains into a common joint embedding space, and the method of operating a computing device includes training a mapping neural network constituting a joint embedding space using an input dataset, generating a prediction matrix of an input dataset using the mapping neural network, and generating a merging dictionary merging classes from the prediction matrix to correct the input dataset.

The generating of the prediction matrix of the input dataset using the mapping neural network may include generating class prediction values for each piece of data included in the input dataset and comparing the class prediction values with ground truth to generate the prediction matrix.

The generating of the class prediction values for each piece of data included in the input dataset may include mapping each piece of data included in the input dataset to the joint embedding space to convert the data into feature vectors, generating class representative values from the feature vectors mapped to the joint embedding space for each class, comparing each feature vector mapped to the joint embedding space with the class representative values to generate the class prediction values for each piece of data included in the input dataset.

The class representative value may include any one of an arithmetic mean value of the feature vectors and an entire set of the feature vectors itself.

The prediction matrix may be composed of a combination of a ground truth label and a predicted class label of a class.

The generating of the merging dictionary merging the classes from the prediction matrix to correct the input dataset may include merging a class corresponding to i into a class corresponding to j when (i, j) is a maximum value of row i for a predicted class label column j corresponding to a ground truth label row i of the prediction matrix and the i and j correspond to different classes.

The generating of the merging dictionary merging the classes from the prediction matrix to correct the input dataset may include excluding a class corresponding to i from a merge target when (i, i) is a maximum value of row i corresponding to a ground truth label row i of the prediction matrix.

An embodiment of the present disclosure discloses a computing device for mapping data from different domain into a common high-dimensional space, and the computing device includes one or more processors configured to train a mapping neural network constituting the joint embedding space using an input dataset, generate a prediction matrix of the input dataset using the mapping neural network, and generate a merging dictionary merging classes from the prediction matrix to correct the input dataset.

The processor may generate class prediction values for each piece of data included in the input dataset, and compares the class prediction values with ground truth to generate the prediction matrix.

The processor may map each piece of data included in the input dataset to the joint embedding space to convert the data into feature vectors, generate class representative values from the feature vectors mapped to the joint embedding space for each class, compare each of the feature vectors mapped to the joint embedding space with the class representative values to generate class prediction values for each piece of data included in the input dataset.

The class representative value may include any one of an arithmetic mean value of the feature vectors and an entire set of the feature vectors itself.

The prediction matrix may be composed of a combination of a ground truth label and a predicted class label of a class.

When (i, j) is a maximum value of row i for a predicted class label column j corresponding to a ground truth label row i of the prediction matrix and the i and the j correspond to different classes, the processor may merge a class corresponding to i into a class corresponding to j to correct the input dataset.

When (i, i) is a maximum value of row i for a predicted class label column j corresponding to a ground truth label row i of the prediction matrix, the processor may exclude a class corresponding to i from a merge target to correct the input dataset.

### BRIEF DESCRIPTION OF THE DRAWINGS

FIG. 1 is a diagram illustrating an artificial intelligence device (100) according to an embodiment of the present disclosure.

FIG. 2 is a diagram illustrating a flowchart according to an embodiment of the present disclosure.

FIG. 3 is a diagram illustrating a configuration of a joint embedding space according to an embodiment of the present disclosure.

FIG. 4 is a diagram illustrating an example of a prediction matrix according to an embodiment of the present disclosure.

FIG. 5 illustrates an example of a merging dictionary according to an embodiment of the present disclosure.

### DETAILED DESCRIPTION OF EXEMPLARY EMBODIMENTS

A technology to be described below may be variously modified and have several exemplary embodiments. Therefore, specific exemplary embodiments of the present disclosure will be illustrated in the accompanying drawings and described in detail. However, it is to be understood that the present disclosure is not limited to the specific exemplary embodiments, but includes all modifications, equivalents, and substitutions without departing from the scope and spirit of the present disclosure.

Throughout the present specification, when any one part is referred to as being “connected to” another part, it means that any one part and another part are “directly connected to” each other or are “electrically connected to” each other with still another part interposed therebetween.

Terms such as “first,” “second,” “A,” “B,” and the like may be used to describe various components, but the components are not to be interpreted to be limited to the terms and are used only for distinguishing one component from other components. For example, a first component may be referred to as a second component and the second component may also be similarly referred to as the first component, without departing from the scope of the present disclosure. The term and/or includes a combination of a plurality of related described items or any one of the plurality of related described items.

It should be understood that the singular expression includes the plural expression unless the context clearly indicates otherwise, and it will be further understood that the terms “comprises” and “have” used in this specification specify the presence of stated features, steps, operations, components, parts, or a combination thereof, but do not preclude the presence or addition of one or more other features, numerals, steps, operations, components, parts, or a combination thereof.

Prior to the detailed description of the drawings, it is intended to clarify that the components in this specification are only distinguished by the main functions of each component. That is, two or more components to be described below may be combined into one component, or one component may be divided into two or more for each subdivided function. In addition, each of the constituent parts to be described below may additionally perform some or all of the functions of other constituent parts in addition to the main functions of the constituent parts, and some of the main functions of the constituent parts may be performed exclusively by other components.

In addition, in performing the method or the operation method, each of the processes constituting the method may occur differently from the specified order unless a specific order is explicitly described in context. That is, the respective steps may be performed in the same sequence as the described sequence, performed at substantially the same time, or performed in a reverse sequence.

Hereinafter, embodiments of the present disclosure will be described below.

First, according to an embodiment of the present disclosure, it should be understood that a computing device 100 may be used to map inputs of a neural network to a joint embedding space and all operations of the present disclosure may be performed by the computing device.

In the training of the neural network of the present disclosure, the neural network may include a neural network that maps data of different domains to a common high-dimensional joint embedding space, which will be referred to as a mapping neural network.

The mapping neural network corresponds to neural networks that may generate correspondences between different domains by utilizing joint embedding space, and the neural network may be trained using a dataset. The dataset used for the training may have a significant effect on a training result and the quality of the neural network.

The present disclosure has been made to solve the above conventional problems, and the computing device 100 may simultaneously perform training of a mapping neural network that maps data to a joint embedding space and refinement of a dataset.

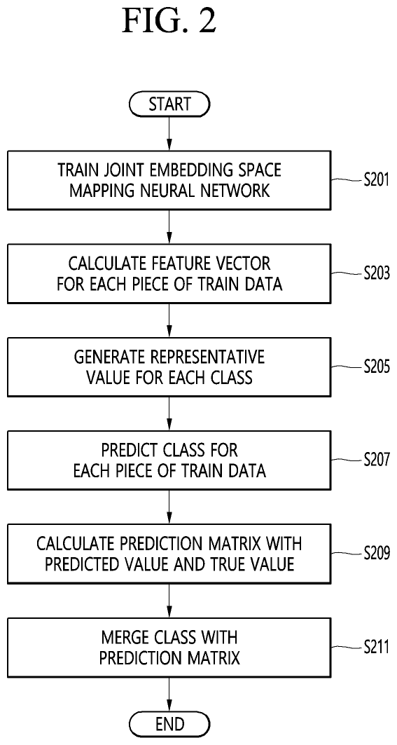

Specifically, the operation of the computing device 100 according to the embodiment of the present disclosure is illustrated in the flowchart of FIG. 2, and the contents are summarized as follows.

An operation of training, by a computing device, mapping neural networks that maps data to a joint embedding space using an input dataset, an operation of mapping input data belonging to each class to the joint embedding space using the trained mapping neural network and converting the input data into feature vectors, an operation of generating class representative values from the feature vectors mapped for each class, an operation of comparing the feature vectors mapped from inputs with the class representative values to generate class prediction values for the input data and comparing the generated class prediction values with ground truth to calculate a prediction propensity matrix between the classes, and an operation of using a prediction matrix to combine similar classes into one class and refine the dataset may be performed. This will be described below in detail.

First, the configuration of the computing device 100 will be described.

The computing device 100 may include a device that constantly processes input data and performs necessary calculations according to a specific model or algorithm. For example, the computing device may be implemented in the form of a PC, a server on a network, a smart device, a chipset in which a design program is embedded, and the like.

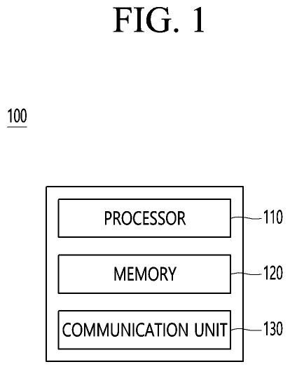

FIG. 1 illustrates the computing device 100 according to the embodiment of the present disclosure.

FIG. 1 illustrates a block configuration diagram of a computing device according to one embodiment of the present disclosure. The components of computing device 100 illustrated in FIG. 1 are exemplary. Only some of the components illustrated in FIG. 1 may constitute the computing device 100, and additional component(s) other than the components illustrated in FIG. 1 may be included in the computing device 100 that provides realistic visualization.

As illustrated in FIG. 1, the computing device 100 may include a processor 110, a memory 120, and a communication unit 130.

The communication unit 130 may transmit and receive data to and from external devices such as other electronic devices or servers using wired/wireless communication technology. For example, the communication unit 130 may transmit and receive sensor information, a user input, a training model, a control signal, and the like to and from external devices.

The memory 120 may store data supporting various functions of the computing device 100. The memory 120 may store data necessary for training the neural network, and the trained neural network may be stored in the memory 120. In addition, it is possible to receive training data through the server and train the neural network using the received data.

The processor 110 may determine at least one executable operation of the computing device 100. Also, the processor 110 may perform the determined operation by controlling components of the computing device 100.

To this end, the processor 110 may request, search for, receive, or utilize data in the memory 120 and control components of the computing device 100 to execute a predicted operation or an operation determined to be preferable of the at least one executable operation.

In this case, when it is necessary to link the external device to perform the determined operation, the processor 110 may generate a control signal for controlling the external device and transmit the generated control signal to the external device.

The processor 110 may control at least some or a combination of components of the computing device 100 to execute an application program stored in the memory 120.

The computing device 100 according to the embodiment of the present disclosure may transmit and receive data through an interconnection through wireless and/or wired communication. The computing device of the present disclosure may include any type of computing device capable of calculating data in electronic form.

For example, the computing device may be implemented as a stationary device or a movable device such as a server, a TV, a projector, a portable phone, a smart phone, a desktop computer, a notebook computer, a digital broadcasting terminal, personal digital assistants (PDAs), a portable multimedia player (PMP), a navigation system, a tablet PC, a wearable device, a set-top box (STB), a digital multimedia broadcasting (DMB) receiver, a radio, a washing machine, a refrigerator, a desktop computer, a digital signage, a robot, and a vehicle.

FIG. 2 is a diagram illustrating a flowchart according to an embodiment of the present disclosure.

Referring to FIG. 2, as described above, the computing device 100 according to the embodiment of the present disclosure may simultaneously perform training of a mapping neural network mapping data to a joint embedding space and refinement of a dataset, and the above operation may include initially training the mapping neural network that maps data to the joint embedding space using an input dataset (S201).

Specifically, operation S201 is an operation of initially training the neural network that maps the data to the joint embedding space using the input dataset.

According to an embodiment of the present disclosure, the computing device 100 may map input data from the same class to nearby positions in the embedding space during training. In addition, the mapping neural network may be trained to map inputs belonging to different classes to distant positions in the embedding space.

In this case, classes of each input data may be set based on whether there is a merging dictionary to be described below. For example, the classes of each input data may be changed using the merging dictionary when the merging dictionary generated in operation S211 exists. When there is no merging dictionary, an initial input class may be used without change.

On the other hand, in the operation S201, the computing device may use a loss function that applies loss values of different criteria to a positive pair and a negative pair, such as contrastive loss or triplet loss when classifying.

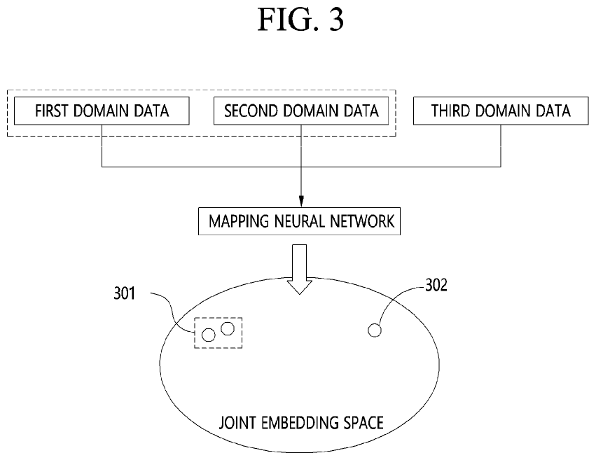

FIG. 3 illustrates an example of a joint embedding space configuration according to an embodiment of the present disclosure. Referring to FIG. 3, according to an embodiment, when the input data for training is ideal, the mapping neural network trained through the operation S201 may extract features from inputs (first to third domain data). When the first domain data and the second domain data are the same class (301), a similar feature vector having a high degree of similarity in the joint embedding space with respect to the corresponding domain data may be extracted.

In addition, meanwhile, like the third domain data, other classes 302 are mapped to different regions in the joint embedding space, and different feature vectors may be extracted.

However, when an incorrect class label is specified in the input data due to an error in the input data, or there is little or no difference between the classes and thus two classes are indistinguishable from the input data, the neural network distinguishing the input data into the specified class may not be trained properly, and thus, inputs of different classes may be mapped to close positions in the embedding space, or the training of the neural network fails, and thus, the inputs of different classes may not be mapped to close positions.

The computing device according to the embodiment of the present disclosure may perform an operation of mapping input data belonging to each class to the joint embedding space using the trained mapping neural network and converting the input data into the feature vectors (S203). The computing device 100 may include generating class representative values from feature vectors mapped to each class (S205).

For example, the representative value may include an arithmetic mean value of feature vectors or an entire set of feature vectors itself.

Meanwhile, it is also possible to use a classification neural network as a representative value by training the neural network that classifies the class in the feature vector without using the representative value as described above.

The computing device 100 according to the embodiment of the present disclosure may compare the feature vectors mapped from the input with the class representative values to generate a class prediction value for the input data (S207). In detail, operation S207 may include predicting classes for each input data using the trained neural network and the representative values.

By applying the trained mapping neural network to one input data through the above process, the feature vector may be calculated, and the prediction class label may be calculated using the feature vectors and the representative values generated in operation S205.

The above process may be performed to prevent the case where the input is not classified into a class specified in ground truth, when the neural network does not extract sufficient features for the input or when the training is not good such as when there is little difference between the classes.

The computing device according to the embodiment of the present disclosure may perform an operation of calculating a prediction propensity matrix between classes by comparing the generated class prediction value with the ground truth (S209).

In this way, the computing device 100 may predict the class for all the input data, and then calculate the prediction matrix indicating which class is predicted for each class.

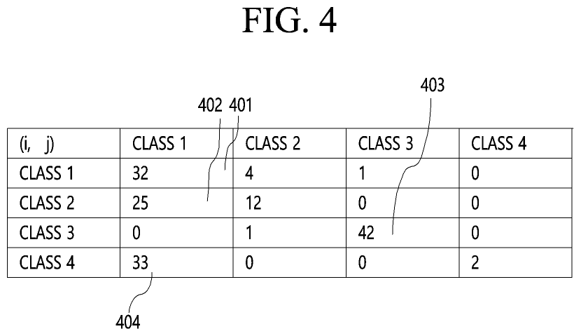

Hereinafter, the prediction matrix will be described with reference to FIG. 4.

FIG. 4 illustrates an example of the prediction matrix according to an embodiment of the present disclosure.

Referring to FIG. 4, the prediction matrix may be composed of a combination of a ground truth label and a predicted class label of a class.

In other words, each row of the prediction matrix may be the ground truth label, and each column may be the predicted label.

For example, when there are y pieces of data in which the ground truth label is i and the predicted class label is j according to an embodiment of the present disclosure, a (i, j) value of the matrix may be y.

In addition, when the prediction is correct, since the prediction result of the data whose ground truth label is i should be i, when the (i, i) value is large for each input label i, the neural network may determine that the feature vector is correctly extracted.

In addition, when the value of (i, j) is large for j different from i, the neural network may determine that the feature vector has not been correctly extracted.

Referring to FIG. 4, when (i, j) is a maximum value of row i for a predicted class label column j corresponding to a ground truth label row i of the prediction matrix and the i and j correspond to different classes, the method may include merging a class corresponding to i into a class corresponding to j. In addition, when (i, i) is a maximum value of row i corresponding to a ground truth label row i of the prediction matrix, the method may include excluding a class corresponding to i from a merge target.

For example, for labels that are ground truth for class 1 and class 3, the (i, i) value for each input label i is mapped to the largest value compared to other values, so it may be determined that the prediction accuracy is high, and for data of classes 2 and 4, the prediction accuracy may be determined to be low because many of the predicted class labels corresponding to the ground truth labels are mapped to class 1.

FIG. 2 will be described again.

After calculating the prediction matrix, the computing device according to the embodiment of the present disclosure may merge similar classes into one class using the calculated prediction matrix (S211).

For example, when (i, i) has the maximum value for each row i, the computing device may determine that the mapping neural network has successfully extracted the feature vector for the corresponding class, and exclude the feature vector from the merge target. This may correspond to 401 and 403 of FIG. 4.

In addition, when (i, j) is the maximum value for i and another j and the corresponding value exceeds a predetermined criterion, the computing device may determine that the mapping neural network is unable to distinguish classes i and j, and merge i into j. This may correspond to 402 and 404 of FIG. 4.

In this case, the predetermined criterion may include a case where the value is greater than or equal to a standard ratio than the total sum of input i. In addition, as the reference ratio is set to a lower value, more classes may be merged, but since the probability of incorrectly merging classes that should exist independently increases, the reference ratio should be set to an appropriate value.

The computing device according to an embodiment of the present disclosure may generate the merging dictionary based on the above operation.

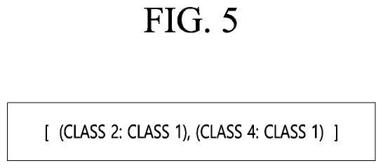

FIG. 5 illustrates an example of the merging dictionary according to an embodiment of the present disclosure.

Referring to FIG. 5, the merging dictionary may mean a matrix for representing a merged class among the prediction matrices.

The computing device may initialize the merging dictionary to an empty set at the start and update the merging dictionary until the end. For example, when class i of the prediction matrix is merged into j, the computing device may add (i, j) to the merging dictionary.

For example, the (i, j) of the prediction matrix to be added to the merging dictionary may correspond to 402 and 404 in FIG. 4.

The computing device 100 may merge similar classes into one class using the prediction matrix. Due to the merger, the mapping (i:j) of the class j to be replaced for each class i may be stored in the merging dictionary.

The computing device may generate the merging dictionary as described above and then update the input dataset.

Specifically, for the input dataset, a dataset in which i is merged into j for all (i, j) in the merging dictionary may be ultimately generated.

For example, in the case of (class 2:class 1) in FIG. 5, for data classified into class 2, the input dataset may be updated to class 1, and in the case of (class 4:class 1), for data classified into class 4, the input dataset may be updated to class 1.

The computing device 100 according to the embodiment of the present disclosure may repeatedly perform operations S201 to S211.

After repeatedly performing the above operation, when there is no more correspondence added to the merging dictionary, this process may end. The neural network trained by the above process may ultimately be the mapping neural network that maps the input to the joint embedding space, and the dataset to which the final merging dictionary is applied may be the refined dataset.

As described above, when the method of the present disclosure is applied, the dataset may be refined simultaneously with training the neural network, and since the dataset is refined, the accuracy of the training result of the neural network increases, and at the same time, the refined dataset may be obtained, thereby increasing the accuracy and reducing the training time.

The present disclosure described above can be embodied as a computer readable code on a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and the like.

The present disclosure can obtain a refined dataset while increasing the accuracy of a training result of a neural network by performing an operation of correcting data that is less related to an error of the dataset and a problem to be trained using the neural network at the same time as the training of the neural network, thereby reducing the training time as well we increasing the accuracy.

What is claimed is:

1. A method of operating a computing device for mapping data from different domains into a common joint embedding space, the method comprising:
training a mapping neural network constituting a joint embedding space using an input dataset;
generating a prediction matrix of an input dataset using the mapping neural network; and
generating a merging dictionary merging classes from the prediction matrix to correct the input dataset.

2. The method of claim 1, wherein the generating of the prediction matrix of the input dataset using the mapping neural network includes:
generating class prediction values for each piece of data included in the input dataset; and
comparing the class prediction values with ground truth to generate the prediction matrix.

3. The method of claim 2, wherein the generating of the class prediction values for each piece of data included in the input dataset includes:
mapping each piece of data included in the input dataset to the joint embedding space to convert the data into feature vectors;
generating class representative values from the feature vectors mapped to the joint embedding space for each class; and
comparing each feature vector mapped to the joint embedding space with the class representative values to generate the class prediction values for each piece of data included in the input dataset.

4. The method of claim 3, wherein the class representative value includes any one of an arithmetic mean value of the feature vectors or an entire set of the feature vectors itself.

5. The method of claim 1, wherein the prediction matrix is composed of a combination of a ground truth label and a predicted class label of a class.

6. The method of claim 1, wherein the generating of the merging dictionary merging the classes from the prediction matrix to correct the input dataset includes merging a class corresponding to i into a class corresponding to j when (i, j) is a maximum value of row i for a predicted class label column j corresponding to a ground truth label row i of the prediction matrix and the i and j correspond to different classes.

7. The method of claim 1, wherein the generating of the merging dictionary merging the classes from the prediction matrix to correct the input dataset includes excluding a class corresponding to i from a merge target when (i, i) is a maximum value of row i corresponding to a ground truth label row i of the prediction matrix.

8. A computing device for mapping data from different domains into a common joint embedding space, the computing device comprising one or more processors configured to:
train a mapping neural network constituting the joint embedding space using an input dataset;
generate a prediction matrix of the input dataset using the mapping neural network; and
generate a merging dictionary merging classes from the prediction matrix to correct the input dataset.

9. The computing device of claim 8, wherein the processor generates class prediction values for each piece of data included in the input dataset and compares the class prediction values with ground truth to generate the prediction matrix.

10. The computing device of claim 9, wherein the processor maps each piece of data included in the input dataset to the joint embedding space to convert the data into feature vectors, generates class representative values from the feature vectors mapped to the joint embedding space for each class, compares each of the feature vectors mapped to the joint embedding space with the class representative values to generate class prediction values for each piece of data included in the input dataset.

11. The computing device of claim 10, wherein the class representative value includes any one of an arithmetic mean value of the feature vectors or an entire set of the feature vectors itself.

12. The computing device of claim 8, wherein the prediction matrix is composed of a combination of a ground truth label and a predicted class label of a class.

13. The computing device of claim 8, wherein, when (i, j) is a maximum value of row i for a predicted class label column j corresponding to a ground truth label row i of the prediction matrix and the i and j correspond to different classes, the processor merges a class corresponding to i into a class corresponding to j to correct the input dataset.

14. The computing device of claim 8, wherein, when (i, i) is a maximum value of row i for a predicted class label column j corresponding to a ground truth label row i of the prediction matrix, the processor excludes a class corresponding to i from a merge target to correct the input dataset.
